(19) United States
(12) Patent Application Publication
(10) Pub. No.: US 2025/0329492 A1
(43) Pub. Date: Oct. 23, 2025

(54) ACTIVE POWER TRANSFORMER FOR CONTROLLING NON-UNIFORM VOLTAGE

(71) Applicant: JUNGIN TECHWIN CO.,LTD., Ansan-si, Gyeonggi-do (KR)

(72) Inventor: Kisung KIM, Seoul (KR)

(73) Assignee: JUNGIN TECHWIN CO.,LTD., Ansan-si, Gyeonggi-do (KR)

(21) Appl. No.: 18/867,599

(22) PCT Filed: May 23, 2022
(86) PCT No.: PCT/KR2022/007316

§ 371 Date: Nov. 20, 2024

(51) Int. Cl. H01F 30/12; H01F 27/30; H01F 27/38

(52) U.S. Cl. CPC H01F 30/12; H01F 27/306; H01F 27/385

(57) ABSTRACT

An active power transformer for controlling non-uniform voltage, of the present invention, comprises a plurality of zigzag wiring parts that are symmetrically-structured and are connected to a power source system having three-phase wiring for supplying an alternating current power source to a load, wherein the plurality of zigzag wiring parts has a core having three legs, four windings of a three-phase transformer are wound around each leg in the same direction so as to be symmetrical to each other, a second lead wire of a winding of a neighboring phase is connected to a first lead wire of a winding for the transformer, which is wound around a leg of each phase, through a lead connection wire so as to form a terminal of each phase, and the lead wires of the remaining windings are connected to a neutral point, and the respective lead connection wires do not intersect with each other, and thus a safer active power transformer for controlling non-uniform voltage is possible.

### BACKGROUND OF THE INVENTION

### Field of the Invention

The present invention relates to a three-phase power transformer, and more particularly, to a three-phase wiring power transformer in which pairs of zigzag-connected transformers that are symmetrical to each other are combined and the lead connection wires are spatially separated so that the lead connection wires do not overlap each other, thereby enabling safe use even at high power and improving power efficiency.

### Description of the Related Art

Since the invention of electricity and the use of alternating current, humans have been unable to use electricity without a transformer. That is, since high voltage supply is efficient in the distribution system, high voltage transmission is required, and the closer it is to the consumer, the more stable and relatively low voltage transformation is required. Therefore, transformers are inseparable from electricity, including transmission.

Moreover, since the history of using three-phase power supply, the problem of harmonic power has emerged in the 21st century for various reasons including the problem of balance in ultra-high voltage transmission.

Harmonics are caused when devices that use normal frequencies do not use all of the power they consume and instead return some of it to the power lines, which then circulates as power waste and causes various problems.

Problems include destruction of capacitors due to oversaturation of their capacitance as the frequency increases, excessive increase in the capacitance of the neutral wire, uneven motor speed, and noise in various control equipment.

Existing harmonic filters include passive filters, active filters, and image harmonic filters. In a passive filter, a specific frequency and a specific current are set, and that specific frequency and specific current are attenuated. However, if it is less than that specific frequency and current, attenuation is not performed well, and if the current exceeds a certain level, it will overheat and be damaged.

Active filters have the problem that harmonics may be generated if the electronic equipment is faulty because they previously generated an inverse frequency of a specific frequency using electronic equipment to cancel it out, and they are also quite expensive.

The image harmonic filter is an active filter with a zigzag wiring structure, but some of the image harmonics are attenuated (about 50%).

Meanwhile, as a first prior art related to a harmonic filter and transformer, a technology such as Korean Patent Unexamined Publication No. 2014-0032300 (Hybrid transformer for harmonic removal) is disclosed.

The above first prior art relates to a hybrid transformer for harmonic removal, which improves power quality by providing a transformer capable of suppressing the 5th harmonic and other harmonic orders based on the 3rd harmonic, thereby eliminating overheating of a neutral wire and excessive heating of a transformer case due to harmonics, reducing power loss due to harmonic current, thereby increasing efficiency, and ensuring the lifespan of equipment.

The above first prior art is characterized by including secondary and tertiary low-voltage windings (zigzag windings) made of windings having a phase of 180 degrees with respect to the harmonic order occurring in the load, based on the primary high-voltage winding (delta winding) of the transformer.

However, in the case of the above first prior art, many windings such as primary, secondary, and tertiary are required, and strictly speaking, if separate primary side windings are considered, it becomes a 4-winding transformer with 4 windings in total, and accordingly, the size also increases and it is extremely inefficient.

On the other hand, as a second prior art related to a harmonic filter and transformer, a technology such as the inventor's Korean Patent Registration No. 1828831 (power transformer with improved harmonic attenuation and high current phase recovery function) is disclosed.

The above second conventional technology provides a three-phase electric transformer that can be used as a phase loss recovery device to prevent a phase loss accident in an emergency, and that can minimize the size even at high currents by dispersing the phase current, and further improves power quality by attenuating not only zero harmonics but also 5th and 7th harmonics.

The transformer of the above second prior art is a transformer having a delta-zigzag wiring part connected to a power source system having a three-phase connection for supplying AC power to a load, wherein the delta-zigzag wiring part has a single-winding core having three legs, and a winding of a three-phase transformer and a winding for phase loss recovery are wound for each leg, and the windings of the three-phase transformer are connected in a delta-type connection structure, and a tap at a point divided into three equal parts of the windings for transformer wound for each leg of the phase is connected to one end of a winding for phase loss recovery of an adjacent phase, and the other end of each winding for phase loss recovery is connected to a neutral point, and the number of turns of each of the windings for phase loss recovery is ⅓ of the corresponding one of the windings of the three-phase transformer.

However, in the case of the delta-zigzag method of the second prior art, although it has harmonic attenuation and phase recovery functions, there was a limitation that the efficiency of the delta winding in phase multiple was not very high.

Accordingly, the inventor of the present invention, in order to solve the problems of the first and second prior arts, has proposed a three-phase electric transformer which is installed in parallel to a power line to remove harmonics (active filter), while dispersing the phase current to minimize the size even at high currents, and attenuates not only the zero harmonics but also the 5th and 7th harmonics, thereby further improving power quality, as the third prior art of Korean Patent Registration No. 1931218 (Three-phase power reciprocating transformer having a harmonic active filter function using a three-phase power single-phase transformer).

The third prior art is a transformer having a plurality of zigzag connection sections connected to a power system having a three-phase connection for supplying AC power to a load, wherein the plurality of zigzag connection sections have a single-winding core having three legs, and a zigzag winding of a three-phase transformer and a zigzag symmetrical winding of a three-phase transformer are wound for each leg.

According to the third prior art, in the case of a transformer having a general zigzag connection section, as the capacity increases, the phase loss recovery function is not sufficiently exerted, and in the case of the transformer having multiple zigzag connections of the first prior art, there are too many unnecessary overlapping connections, making it too inefficient, and in the case of the transformer having the delta-zigzag connection section of the second prior art, there was a limitation that when a load of 1 kw was applied, the rated voltage of 220 V dropped by about 10 V in the case of phase loss of one phase, but according to the three-phase power restoration transformer having multiple zigzag connections of the third prior art, it was found that phase loss recovery is possible with only about 7 V of the phase loss even with a very simple configuration, thereby bringing about an increase in phase loss recovery efficiency of about 30%.

However, on the other hand, when a three-phase transformer is used for high power, a three-phase motor may be damaged by a single-phase connection, semiconductors may be damaged by overvoltage, and a capacitor that improves the power factor may generate noise in the power. In the past, the power factor could be controlled, but it is not well controlled in the 21st century. Therefore, a new power factor control mechanism has been requested, and thus a zigzag transformer has been widely used. However, in the case of the third prior art, the lead wires are separated into upper and lower parts, and especially when used for extremely high voltage (e.g. 22,900 V), a large number of lead connection wires must be used. Therefore, there have been occasional problems such as a short circuit occurring due to the proximity of the lead connection wires.

For example, when several pairs of windings are wound on one leg, several lead wires must come out and several lead connection wires intersect. The first lead connection wire and the second lead connection wire do not intersect, but they intersect with the third lead connection wire. As a result, the insulation is effectively broken at the intersecting part, and in some cases, the entire transformer is damaged.

In particular, in the above-mentioned third prior art, since 7 to 9 lead wires come out of one leg and these must be connected with lead connection wires, it was difficult to prevent the lead connection wires from crossing each other at all, which became a serious problem under ultra-high voltage.

Furthermore, in the above-mentioned third prior art, since the direction of the coil wound on the same leg is different, there is a problem that the safety of the transformer is compromised when the balance is broken because the number of turns is different by one or half at the part where the winding direction is changed. Although it worked well at high voltages of several thousand volts, it became a serious problem at ultra-high voltages of tens of thousands of volts.

### SUMMARY OF THE INVENTION

That is, in order to solve the problem of the third prior art in that the actual capacity could not be fully utilized because the lead wires in one phase were only one like a V-wiring transformer instead of two like a delta-wiring transformer, the present invention uses a zigzag connection structure as a power transformer, but combines a left-side zigzag and a right-side zigzag which are symmetrical to each other to create a three-phase rhombus wiring transformer, so that two directions of wires are connected to one phase, and a phenomenon is created in which time flows differently on the left and right sides by 0/3 [Hz], ⅓ [Hz], and ⅔ [Hz] within each frequency of 1 [Hz] within the power frequency of 60 [Hz], compared to the phase recovery capability by a single zigzag connection structure on the left and the right, and the zigzag wiring structure on both the right and left sides generates more than twice the power. As a result, the three-phase rhombus wiring transformer with a zigzag connection structure on the right is intended to propose an active power transformer that can handle uneven voltages with a small size and strong phase recovery capability compared to the same capacity.

In addition, the present invention proposes an active power transformer that secures a safer uneven voltage by pulling out and connecting the lead wires at appropriate locations to eliminate crossing of the lead connection wires.

Furthermore, the present invention proposes an active power transformer that can capture uneven voltage and is easy to manufacture by winding the coils in the same direction regardless of the position of the resonator when winding the coils on each leg.

The above objects and other additional objects will be apparent to those skilled in the art without departing from the technical spirit of the present invention by the appended claims.

In order to achieve the object according to a first aspect of the present invention, active power transformer for controlling non-uniform voltage includes: a plurality of zigzag wiring parts 130 that are symmetrically-structured and are connected to a power source system 100 having three-phase wiring for supplying an alternating current power source to a load 110, and the plurality of zigzag wiring parts 130 has a core having three legs, 131, 132, and 133 four windings of a three-phase transformer are wound around each leg in the same direction so as to be symmetrical to each other, a second lead wire (lead wire \textcircled{5}) of a winding of a neighboring phase is connected to a first lead wire (lead wire \textcircled{8}) of a winding for the transformer, which is wound around a leg of each phase, through a lead connection wire so as to form a terminal of each phase, and the lead wires of the remaining windings are connected to a neutral point.

According to the present invention, a zigzag wiring structure on the left side and the right side generates more than twice the power, and as a result, three-phase rhombus wiring transformer with a zigzag connection structure on the left side and the right side is an active power transformer that can handle uneven voltages with a small size and strong phase recovery ability compared to the same capacity, and since the coils are symmetrical to each other and the lead connections do not cross, it is possible to make an active power transformer that can handle uneven voltages more safely.

### BRIEF DESCRIPTION OF THE DRAWINGS

FIG. 1 is a schematic drawing of a typical transformer core used in an optimal embodiment of the present invention.

FIG. 2 is a diagram schematically illustrating a configuration in which multiple coils are wound around one leg according to an optimal embodiment of the present invention.

FIG, 3 illustrates the types and order of windings used in the present invention.

FIG. 4 is a connection wiring diagram of each coil of a three-phase wiring transformer according to the present invention.

FIG. 5 is a schematic plan view of the connection state of each coil of the three-phase wiring transformer according to the present invention.

FIG. 6 is an equivalent circuit diagram of the connection wiring state of each coil of a three-phase wiring transformer according to the present invention.

FIG. 7 is a diagram illustrating a state in which the circuit diagram of FIG. 6 is installed on a power line.

FIG. 8 is a vector diagram of the connection wiring state of each coil of the three-phase wiring transformer according to the present invention.

FIG. 9 is a diagram for describing an effect of the three-phase wiring transformer according to the present invention.

### DETAILED DESCRIPTION OF THE PREFERRED EMBODIMENT

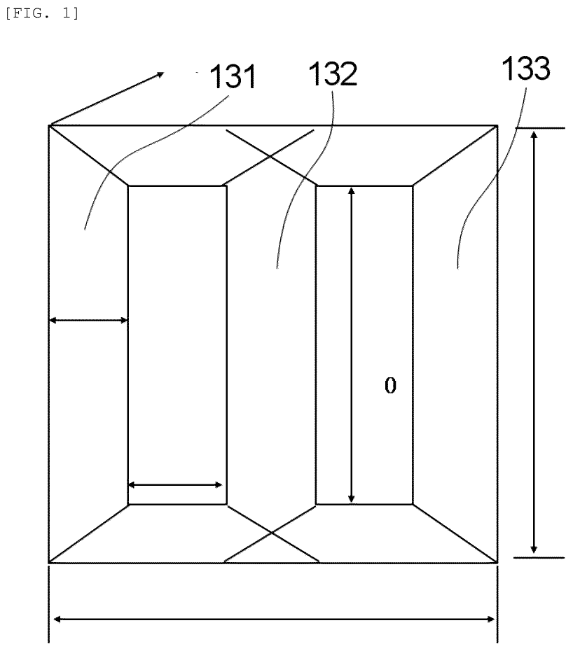

Hereinafter, preferred embodiments of the present invention will be described in more detail with reference to FIGS. 1 to 9 of the attached drawings.

Prior thereto, terms and words used in the present specification and claims should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner.

Therefore, configurations illustrated in the exemplary embodiments and the drawings described in the present invention are only the most preferred embodiment of the present invention and do not represent all of the technical spirit of the present invention, and thus it is to be understood that various equivalents and modified examples, which may replace the configurations, are possible when filing the present application.

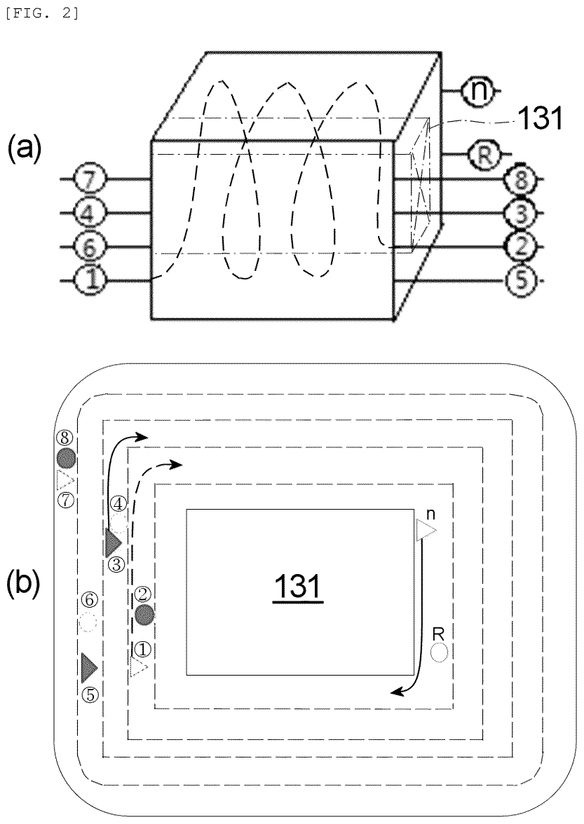

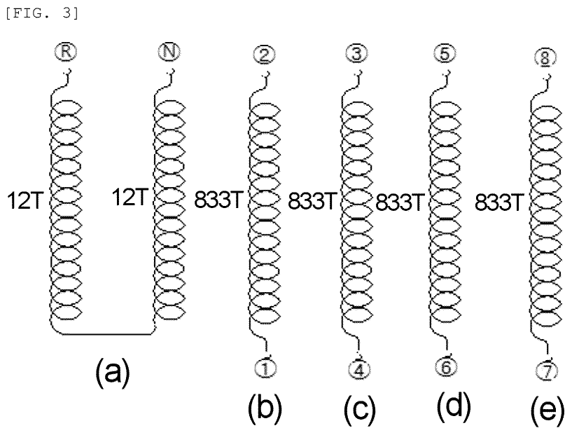

FIG. 1 is a schematic drawing of a typical transformer core used in an optimal embodiment of the present invention, FIG. 2 is a schematically diagram illustrating a configuration in which multiple coils are wound around one leg according to an optimal embodiment of the present invention, and (a) of FIG. 2 is a schematic perspective drawing of windings while a leg is laid down, and (b) of FIG. 2 is a detailed diagram viewed from the right, and FIG. 3 is a diagram illustrating the types and order of windings used in the present invention.

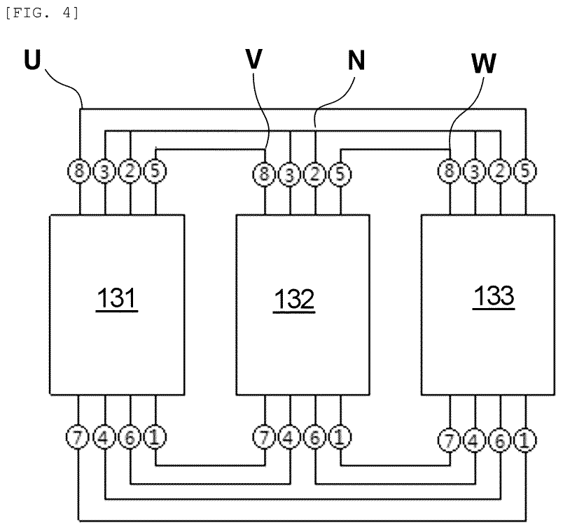

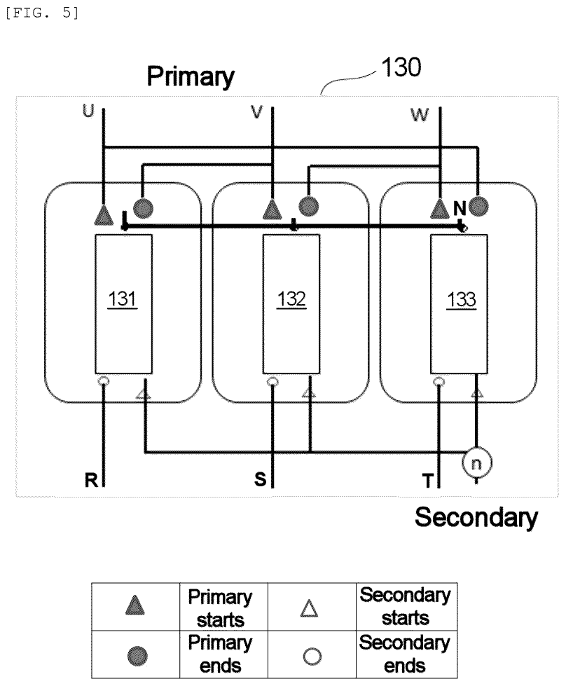

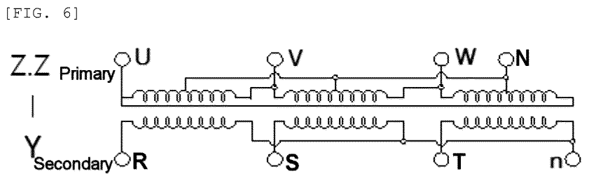

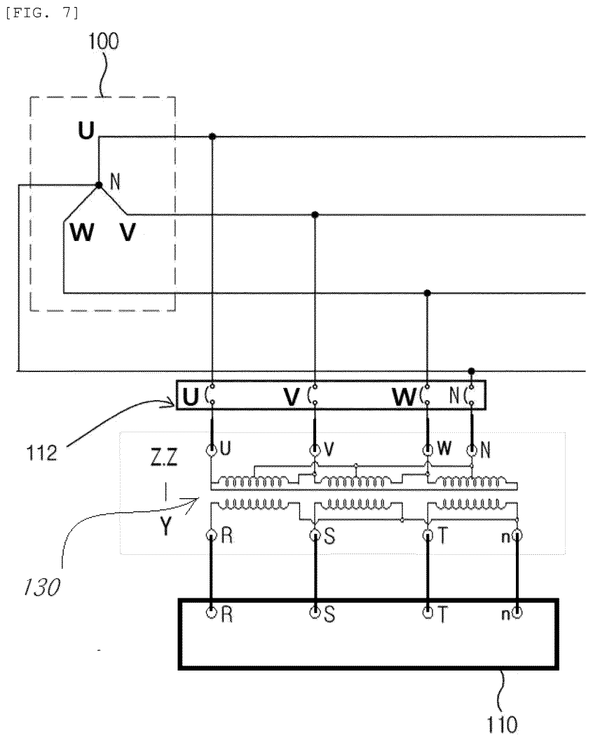

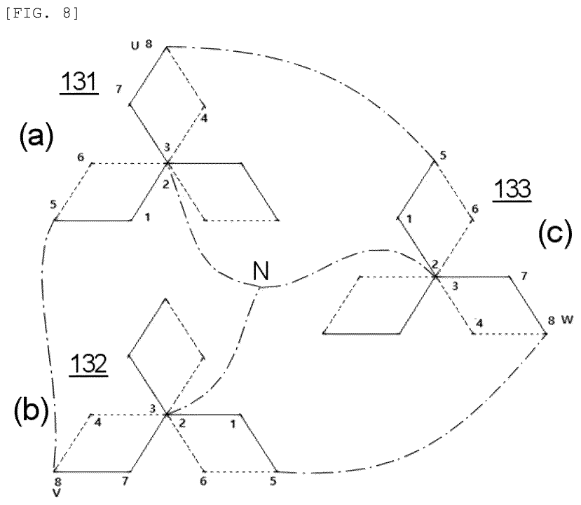

FIG. 4 is a connection wiring diagram of each coil of a three-phase wiring transformer according to the present invention, FIG. 5 is a schematic plan view of the connection state of each coil of the three-phase wiring transformer according to the present invention. FIG. 6 is an equivalent circuit diagram of the connection wiring state of each coil of a three-phase wiring transformer according to the present invention, FIG. 7 is a diagram illustrating a state in which the circuit diagram of FIG. 6 is installed on a power line, and FIG. 8 is a vector diagram of the connection wiring state of each coil of the three-phase wiring transformer according to the present invention.

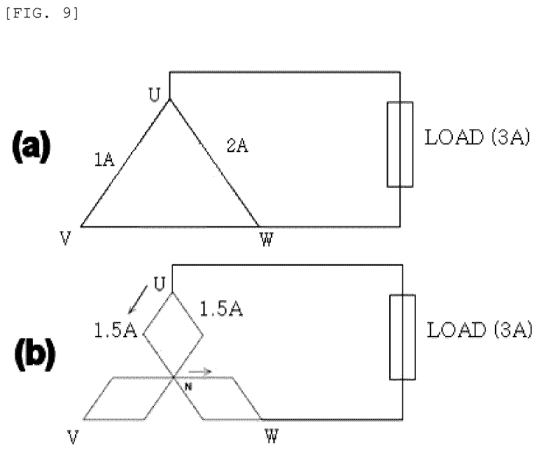

FIG. 9 is a diagram for describing an effect of the three-phase wiring transformer according to the present invention.

The three-phase rhombus wiring transformer according to the present invention is also wound on a U-phase leg 131, a V-phase leg 132, and a W-phase leg 133 as illustrated in FIGS. 1 to 3. The secondary winding may follow the conventional three-phase delta wiring or Y wiring method (Y wiring method in the exemplary embodiment (®\textcircled{n})), and the winding can also be made as illustrated in FIG. 3A, for example, using a square winding with a cross section of 2*6.5 mm²>, and can be wound 12 times, but can be doubled for a total of 24 turns.

On the other hand, the primary winding, which is connected to an ultra-high voltage of about tens of thousands of volts, must have a number of turns that is hundreds of times that of the secondary winding, so a thinner winding (enameled wire with a diameter of 1 to 2 mm, for example) is used and wound on the outside of the secondary winding in a manner as illustrated in FIG. 2, for example 833 turns.

More specifically, for example, on one side (the lower left side when viewed from (a) of FIG. 2) of the innermost layer, the starting lead wire \textcircled{1} (later named ‘start U1’, ‘start V1’, and ‘start W1’, respectively) is wound in one direction (for example, clockwise) around the U-shaped leg (131) and comes out as the ending lead wire \textcircled{2} (later named ‘end U2’, ‘end V2’, and ‘end W2’, respectively) on the opposite side (the second from the right bottom when viewed from FIG. 2) (when viewed from FIG. 2B, it is wound in the direction of the dotted arrow from the lower side), and then slightly above the lead wire \textcircled{2}, the starting lead wire \textcircled{3} (later named ‘start U3’, ‘start V3’, and ‘start W3’, respectively) is also wound in the same direction (for example, clockwise) to the ending lead wire \textcircled{4}. (later named ‘end U4’, ‘end V4’, and ‘end W4’, respectively) is made to come out on the above side (the second from the left when viewed from (a) of FIG. 2) (when viewed from (b) of FIG. 2, it is wound in the direction of the solid arrow from the top), at this time, lead wire \textcircled{1} is wound in the innermost 1st layer, and lead wire \textcircled{3} is wound in the next 2nd layer, and it is preferable that the 1st layer and the 2nd layer be insulated with insulating paper indicated by a dotted line. For reference, (b) of FIG. 2 is a detailed diagram of the legs and windings in (a) of FIG. 2 as viewed from the right side, and in (b) of FIG. 2, \textcircled{8}, \textcircled{3}, \textcircled{2}, and \textcircled{5} indicate right-side lead wires and are expressed as solid lines, whereas \textcircled{7}, \textcircled{4}, \textcircled{6}, and \textcircled{1} indicate opposite (left-side) lead wires and are expressed as dotted lines.

Continuing, lead wire \textcircled{5} is wound in one direction (for example, clockwise) from the bottom side (the lower right side when viewed from (a) of FIG. 2) so that it comes out as lead wire \textcircled{6} on the opposite side (the second from the bottom left when viewed from (a) of FIG. 2), and then lead wire \textcircled{7} is wound in one direction (for example, clockwise) from the top side (the upper left side when viewed from (a) of FIG. 2) so that it comes out as lead wire \textcircled{8} on the opposite side (the upper right side when viewed from (a) of FIG. 2), so that they are symmetrical to each other. Likewise, at this time, lead wire \textcircled{7} is wound in the next 3rd layer, and lead wire \textcircled{7} is wound in the next 4th layer. It is desirable to insulate between the 3 and 4th layers with insulating paper indicated by dotted lines. However, lead wires 2 and 3 are the same neutral wire, so they may or may not be insulated.

However, the above left-right and clockwise directions are relative, and the above left-right and clockwise directions may be changed, and it will be clear to those skilled in the art that the clockwise direction may be uniformly replaced with the counterclockwise direction.

In the same scheme, zigzag coils are wound on the V-phase leg 132 and the W-phase leg 133, and now, by connecting these lead wires with mutual lead connection wires as shown in FIG. 4, the zigzag wiring part 130 of the present invention is formed.

For example, when the \textcircled{8} lead line of the U-phase leg 131 is connected to the \textcircled{5} lead line of the W-phase leg 133, a ‘U-phase’ terminal is formed (at this time, the \textcircled{7} lead line of the U-phase leg 131 is connected to the \textcircled{1} lead line of the W-phase leg 133 to form symmetry), when the \textcircled{5} lead line of the U-phase leg 131 is connected to the \textcircled{8} lead line of the V-phase leg 133, a ‘V-phase’ terminal is formed (at this time, the \textcircled{1} lead line of the U-phase leg 131 is connected to the \textcircled{7} lead line of the W-phase leg 133 to form symmetry), when the \textcircled{5} lead line of the V-phase leg 131 is connected to the \textcircled{8} lead line of the W-phase leg 133, a ‘W-phase’ terminal is formed (at this time, the \textcircled{1} lead line of the V-phase leg 131 is connected to the \textcircled{7} lead line of the W-phase leg 133 (Also ensure that it is symmetrical when connected to the lead wire). The remaining lead wires (lead wires \textcircled{2} and \textcircled{3} of each leg 131, 132, or 133) are interconnected to form an ‘N-phase terminal, and at this time, lead wire \textcircled{6} of each leg 131, 132, or 133 is interconnected with lead wire \textcircled{4} of the adjacent leg.

That is, four coils of the same thickness and length are wound in the same direction on each leg, and the lead wires are connected symmetrically to ensure complete electrical symmetry.

Now, as illustrated in FIG. 5, after the second Δ and ∘ in FIG. 5), the primary winding is wound in the same scheme as described above on the outside of the secondary winding (indicated by ▴ and ● in FIG. 5), and the zigzag winding according to the present invention is completed.

That is, by winding the actual coils and exposing some of the lead wires to the outside, and then inserting legs inside to connect the lead wires, the zigzag wiring part 130 according to the present invention is completed.

Meanwhile, the equivalent circuit diagram of the zigzag wiring part 130 of the present invention is illustrated in FIG. 6, and the entire transformer circuit including the zigzag wiring part 130 expressed as the equivalent circuit is illustrated in FIG. 7.

Meanwhile, vector diagrams for analyzing the effects of these circuits are illustrated in FIG. 8. (a) of FIG. 8 is a rhombus-shaped vector diagram of the U-phase leg (131) winding, (b) of FIG. 8 is a rhombus-shaped vector diagram of the V-phase leg (132) winding, and (c) of FIG. 8 is a rhombus-shaped vector diagram of the W-phase leg (133) winding. Likewise, it can be seen that the terminals of each phase are connected, and when the lead wire \textcircled{8} of the U-phase leg 131 is connected to the lead wire \textcircled{5} of the W-phase leg 133, a ‘U-phase’ terminal is formed, when the lead wire \textcircled{5} of the U-phase leg 131 is connected to the lead wire \textcircled{8} of the V-phase leg 133, a ‘V-phase’ terminal is formed, when the lead wire \textcircled{5} of the V-phase leg 131 is connected to the lead wire \textcircled{8} of the W-phase leg 133, a ‘W-phase’ terminal is formed, and when the remaining lead wires (lead wires \textcircled{2} and \textcircled{3} of each leg 131, 132, or 133) are interconnected, an ‘N-phase terminal’ is formed.

For convenience of description, among the four pairs of windings wound around the first leg 131, the 1-1^{st} winding starts from lead wire \textcircled{1} and is wound around lead wire \textcircled{2}, and is expressed as ‘start U1’ and ‘end U2’, the 1-2^{nd} winding starts from lead wire \textcircled{3} and is wound around lead wire \textcircled{4}, and is expressed as ‘start U3’ and ‘end U4’, the 1-3^{rd} winding starts from lead wire \textcircled{6} and is wound around lead wire \textcircled{6}, and is expressed as ‘start U5’ and ‘end U6’, and the 1-4^{th} winding starts from lead wire \textcircled{7} and is wound around lead wire \textcircled{8}, and is expressed as ‘start U7’ and ‘end U8’.

Similarly, among the four pairs of windings wound around the first leg 132, the 2-1^{st} winding starts from lead wire \textcircled{1} and is wound around lead wire \textcircled{2}, and is expressed as ‘start V1’ and ‘end V2’, the 2-2^{nd} winding starts from lead wire \textcircled{3} and is wound around lead wire \textcircled{4}, and is expressed as ‘start V3’ and ‘end V4’, the 2-3^{rd} winding starts from lead wire \textcircled{5} and is wound around lead wire \textcircled{6}, and is expressed as ‘start V5’ and ‘end V6’, and the 2-4^{th} winding starts from lead wire \textcircled{7} and is wound around lead wire \textcircled{8}, and is expressed as ‘start V7’ and ‘end V8’.

In the same scheme, among the four pairs of windings wound around the first leg 133, the 3-1^{st} winding starts from lead wire \textcircled{1} and is wound around lead wire \textcircled{2}, and is expressed as ‘start W1’ and ‘end W2’, the 3-2^{nd} winding starts from lead wire \textcircled{3} and is wound around lead wire \textcircled{4}, and is expressed as ‘start W3’ and ‘end W4’, the 3-3^{rd} winding starts from lead wire \textcircled{5} and is wound around lead wire \textcircled{6}, and is expressed as ‘start W5’ and ‘end W6’, and the 3-4^{th} winding starts from lead wire \textcircled{7} and is wound around lead wire (8), and is expressed as ‘start W7’ and ‘end W8’.

Finally, in the active power transformer of the present invention for controlling non-uniform voltage, four types of windings: the 1-1^{st} winding (start U1 and end U2); the 1-2^{nd} winding (start U3 and end U4); the 1-3^{rd} winding (start U5 and end U6); and the 1-4^{th} winding (start U7 and end U8) have the same number of turns, the same thickness, and the same direction, and in the case of the 2^{nd} core 132, four types of windings: the 2-1^{st} winding (start V1 and end V2); the 2-2^{nd} winding (start V3 and end V4); the 2-3^{rd} winding (start V5 and end V6); and the 2-4 winding (start V7 and end V8) have the same number of turns, the same thickness, and the same direction, and in the case of the 3rd core 133, four types of windings: the 3-1^{st} winding (start W1 and end W2); the 3-2^{nd} winding (star W3 and end W4); the 3-3^{rd} winding (start W5 and end W6); and the 3-4^{th} winding (start W7 and end W8) have the same number of turns, the same thickness, and the same direction, and at this time, the upper lead positions of the first core 131 are in the order of start U8, start U3, start U2, and start U5 from the left, and the lower lead positions are in the order of start U7, start U4, start U6, and start U1 from the left, the upper lead positions of the second core 132 are in the order of start V8, start V3, start V2, and start V5 from the left, and the lower lead positions are in the order of start V7, start V4, start V6, and start V1 from the left, and the upper lead positions of the third core 133 are in the order of start W8, start W3, start W2, and start W5 from the left, and the lower lead positions are in the order of start W7, start W4, start W6, and start W1 from the left.

In addition, in the winding lead connections of the three-phase wiring transformer for each of the above legs, a 1-1^{st} lead connection part (start U7 and start W1); a 1-2^{nd} lead connection part (end U4 and end W6); a 1-3^{rd} lead connection part (end U6 and end V4); a 1-4^{th} lead connection part (start U1 and start V7); a 1-5^{th} lead connection part (end V6 and end W4); and a 1-6^{th l}ead connection part (start V1 and start W7) form a “first rhombus winding part”, and a 2-1^{st} lead connection part (start W5 and end U8, and power supply U-phase); a 2-2^{nd} lead connection part (end U2 and start U3, end V2 and start V3, and end W2 and start W3, and power supply N-phase); a 2-3^{rd} lead connection part (start U5 and end V8, and power supply V-phase); and a 2-4^{th} lead connection (start V5 and end W8, and power supply W phase) forms a “2^{nd} rhombus winding part”.

Further, preferably, starting from each phase winding core of the U-phase, V-phase, and W-phase, it is good to reinforce the insulation with a first insulating paper (start U1 and end U2); a second insulating paper (start U3 and end U4); a third insulating paper (start U5 and end U6); and a fourth insulating paper (start U7 and end U8).

A three-phase, four-wire zigzag wiring part 130 connected to a high-voltage power system 100 (tens of thousands of volts) to supply low-voltage (220 V to 380 V) AC power to a load 110 as a three-phase rhombus connection transformer for the primary winding includes a core having three legs 131, 132, and 133, a first rhombus wiring part constituted by a 1-1^{st} lead connection part (start U7 and start W1); a 1-2^{nd} lead connection part (start U4 and start W6); a 1-3rd lead connection part (start U6 and start V4); a 1-4^{th} lead connection part (start U1 and start V7); a 1-5^{th} lead connection part (start V6 and start W4) which are wiring connection parts at the bottom of the three-phase rhombus wiring transformer for the legs; and rhombus middle, and a second rhombus wiring part constituted by 2-1^{st} lead connection part (start W5 and end U8, and power supply U-phase); a 2-2^{nd} lead connection part (end U2 and start U3, end V2 and start V3, and end W2 and start W3, and power supply N-phase); a 2-3^{rd} lead connection part (start U5 and end V8, and power supply V-phase); and a 2-4^{th} lead connection (start V5 and end W8, and power supply W phase) which are wiring connection parts at the top, and a rhombus end part.

As described above, the same coil is wound in the same direction, but the lead wires are symmetrical and the lead connection wires do not overlap, so the lead extraction location is accurate and there is no case of the lead wires intersecting each other even at the extra-high voltage of 22900 V, making it safe even at ultra-high voltage.

Also, when phase U is disconnected for a predetermined reason, a similar voltage to the original appears in phase U. The reason is that, in the 2-1^{st} lead connection part (start W5 and end U8, and power supply U phase), the 1-4^{th} winding (end U8 and end U7) is the 4^{th} coil in the 1^{st} leg 131, and the 3-3^{rd} winding (end W5 and end W6) is the 3^{rd} coil in the 3^{rd} leg 133, so the V phase, W phase, and N phase are alive, and therefore the 1-3^{rd} winding (start U5 and end U6), the 2-4^{th} winding (start V7 and end V8), the 2-3^{rd} winding (start V5 and end V6), the 3-4^{th} winding (start W7 and end W8), the 2-2^{nd} winding (start V3 and end V4), the 1-1^{st} winding (start U1 and end U2), the 3-2nd winding (start W3 and end W4), and the 2-1^{st} winding (start V1 and end V2) are alive.

The coil corresponding to the first leg 131 is the 1-3^{rd} winding (start U5 and end U6), the 1-1^{st} winding (start U1 and end U2), the coil corresponding to the third leg 133 is the 3-4^{th} winding (start W7 and end W8), the 3-2^{nd} winding (start W3 and end W4), and power is induced from the 1-3^{rd} winding (start U5 and end U6) (for example, of the 3^{rd} layer) and the 1-1^{st} winding (start U1 and end U2) (for example, of the 1^{st} layer) and power is supplied from the 1-4^{th} winding (start U8 and end U7) (for example, of the 4^{th} layer) to the 4^{th} coil in the 1^{st} leg 131.

Likewise, power is induced in the 3-3^{rd} winding (start

W5 and end W6) (for example, of the 3^{rd} floor) of the 3^{rd} leg 133 from the 3^{rd} coil, the 3-4^{th} winding (start W7 and end W8) (for example, of the 4^{th} floor), and the 3-2^{nd} winding (start W3 and end W4) (for example, of the 2^{nd} floor), so that the 2-1^{st} lead connection part (start W5 and end U8, and power supply U phase) keeps power alive even when the generator and power line are disconnected. At this time, loads exceeding the power of the 3-phase rhombus wiring transformer must be disconnected by a fuse or circuit breaker mutual interlock device. Power recovery by phase failure causes the transformer to act as a generator.

In this way, harmonics are absorbed in the transformer and protect the generator without going to the generator. Power transformers eliminate harmonics, control power factor, and prevent phase loss, which in turn prevents further aging of wires.

And, in the case of a three-phase power source, an unbalanced load may frequently be applied to the transformer, so according to the present invention, it is possible to design a small-sized transformer that reduces power outages by more than 90% and corrects harmonics and uneven voltage. That is, as illustrated in (a) of FIG. 9, in the case of a load with a current of, for example, 3A, in the conventional delta wiring, 2A may flow unbalancedly from the U phase to one side (the W phase), and therefore, a winding capable of accommodating 2A must be used, but as illustrated in (b) of

FIG. 9, in the case of the rhombus-shaped active power transformer of the present invention, 1.5A flows uniformly to both sides, and therefore, in the case of the same three phases, although the current is the same, the active transformer may be smaller in terms of the thickness of the conductors.

To explain this in more detail, “[wire thickness ratio]≈[current ratio] 1.8”, so {(√3)\hat{ }1.8≈2.69}>2.3, so it may be said that they are almost the same. However, in the case of Y·Y wiring, since the neutral point may change, in reality, instead of using a pure Y·Y connection, about 30% of the A wiring is added, so in reality, it becomes a Y·Y·Δwiring, and ultimately, in the case of Z·Z wiring, the wire thickness becomes smaller. In addition, in the case of harmonic loads, [the wire thickness ratio] must be [the current ratio] \hat{ }1.8 or more, so in the case of Z·Z wiring, the wire gauge becomes much smaller. Hereinabove, the present invention has been described based on the best embodiments, but various modifications are possible, and the exemplary embodiments of the present invention described above should not be construed as limiting the technical idea of the present invention. The scope of protection of the present invention is limited only by the matters described in the claims, and a person having ordinary skill in the technical field to which the present invention belongs can improve and change the technical idea of the present invention in various forms. Accordingly, such improvements and modifications will fall within the scope of protection of the present invention as long as they are obvious to a person having ordinary skill in the art.

What is claimed is:

1. An active power transformer for controlling non-uniform voltage, comprising:
a plurality of zigzag wiring parts 130 that are symmetrically-structured and are connected to a power source system 100 having three-phase wiring for supplying an alternating current power source to a load 110,
wherein the plurality of zigzag wiring parts 130 has a core having three legs, 131, 132, and 133 four windings of a three-phase transformer are wound around each leg in the same direction so as to be symmetrical to each other, a second lead wire (lead wire \textcircled{5}) of a winding of a neighboring phase is connected to a first lead wire lead wire \textcircled{8}) of a winding for the transformer, which is wound around a leg of each phase, through a lead connection wire so as to form a terminal of each phase, and the lead wires of the remaining windings are connected to a neutral point.

2. The active power transformer for controlling non-uniform voltage of claim 1, wherein the lead connection wires are configured not to intersect with each other.

3. The active power transformer for controlling non-uniform voltage of claim 1, wherein the winding lead connections of the three-phase wiring transformer for each of the legs include form a first rhombus winding part including a 1-1^{st} lead connection part (start U7 and start W1); a 1-2^{nd} lead connection part (end U4 and end W6); a 1-3^{rd} lead connection part (end U6 and end V4); a 1-4^{th} lead connection part (start U1 and start V7); a 1-5^{th} lead connection part (end V6 and end W4); and a 1-6^{th} lead connection part (start V1 and start W7), and a second rhombus winding part including a 2-1^{st} lead connection part (start W5 and end U8, and power supply U-phase); a 2-2^{nd} lead connection part (end U2 and start U3, end V2 and start V3, and end W2 and start W3, and power supply N-phase); a 2-3^{rd} lead connection part (start U5 and end V8, and power supply V-phase); and a 2-4^{th} lead connection (start V5 and end W8, and power supply W phase).

4. The active power transformer for controlling non-uniform voltage of claim 1, wherein starting from each phase winding core of the U-phase, V-phase, and W-phase, it is good to reinforce the insulation with at least one first insulating paper (start U1 and end U2); at least one second insulating paper (start U3 and end U4); at least one third insulating paper (start U5 and end U6); and a fourth insulating paper (start U7 and end U8).

5. The active power transformer for controlling non-uniform voltage of claim 1, wherein in the case of the 1^{st} core, four types of windings: the 1-1^{st} winding (start U1 and end U2); the 1-2^{nd} winding (start U3 and end U4); the 1-3^{rd} winding (start U5 and end U6); and the 1-4^{th} winding (start U7 and end U8) have the same number of turns, the same thickness, and the same direction, and in the case of the 2^{nd} core 132, four types of windings: the 2-1^{st} winding (start V1 and end V2); the 2-2^{nd} winding (start V3 and end V4); the 2-3^{rd} winding (start V5 and end V6); and the 2-4 winding (start V7 and end V8) have the same number of turns, the same thickness, and the same direction, and in the case of the 3^{rd} core 133, four types of windings: the 3-1^{st} winding (start W1 and end W2); the 3-2^{nd} winding (star W3 and end W4); the 3-3^{rd} winding (start W5 and end W6); and the 3-4^{th} winding (start W7 and end W8) have the same number of turns, the same thickness, and the same direction, and at this time, the upper lead positions of the first core 131 are in the order of start U8, start U3, start U2, and start U5 from the left, and the lower lead positions are in the order of start U7, start U4, start U6, and start U1 from the left, the upper lead positions of the second core 132 are in the order of start V8, start V3, start V2, and start V5 from the left, and the lower lead positions are in the order of start V7, start V4, start V6, and start V1 from the left, and the upper lead positions of the third core 133 are in the order of start W8, start W3, start W2, and start W5 from the left, and the lower lead positions are in the order of start W7, start W4, start W6, and start W1 from the left.
